(19) United States
(12) Patent Application Publication
(10) Pub. No.: US 2026/0260086 A1
(43) Pub. Date: Sep. 3, 2026

(54) INFORMATION PROCESSING APPARATUS AND STORAGE MEDIUM

(71) Applicant: SEIKO EPSON CORPORATION, TOKYO (JP)

(72) Inventor: Takuto MIYASHITA, SHIOJIRI-SHI (JP)

(21) Appl. No.: 19/554,715

(22) Filed: Mar. 3, 2026

(30) Foreign Application Priority Data
Mar. 3, 2025 (JP) 2025-032665

(51) Int. Cl. G06K 15/00; G06K 15/02; G06V 10/25; G06V 30/146; G06V 30/416

(52) U.S. Cl. CPC G06K 15/4065; G06K 15/007; G06K 15/027; G06V 10/25; G06V 30/147; G06V 30/416

(57) ABSTRACT

An information processing apparatus includes an imaging unit, a display, an operation unit, and a controller. The controller acquires a plurality of pieces of captured image data by capturing images of a plurality of original document sheets on which respective page numbers capable of identifying the plurality of original document sheets are written, causes a captured image based on each piece of the captured image data to be displayed on the display, acquires at least one piece of identification region information indicating, in the captured image, a page number region in which a page number is written and that is designated by the operation unit, identifies, for each piece of the captured image data, the page number of a respective one of the original document sheets based on an image in the page number region, and determines the order of the plurality of pieces of captured image data.

The present application is based on, and claims priority from JP Application Serial Number 2025-032665, filed March 3, 2025, the disclosure of which is hereby incorporated by reference herein in its entirety.

### BACKGROUND

### 1. Technical Field

The present disclosure relates to an information processing apparatus and a storage medium.

### 2. Related Art

JP-A-2010-154021 discloses that, in a photographic processing system capable of printing a multi-image in which a plurality of images are arranged, the plurality of images are arranged in an order selected by a user.

However, if there are a large number of images to be arranged, a process in which a user selects each image, that is, a process of specifying the order of images, becomes complicated.

### SUMMARY

According to an aspect of the present disclosure, an information processing apparatus includes an imaging unit, a display, an operation unit, and a controller. The controller is configured to acquire a plurality of pieces of captured image data by capturing, with the imaging unit, images of a plurality of imaging objects on which respective pieces of identification information capable of identifying the plurality of imaging objects are written, to cause a captured image based on each piece of the captured image data to be displayed on the display, to acquire at least one piece of identification region information indicating, in the captured image, an identification region in which the identification information is written and that is designated by the operation unit, to identify, for each piece of the captured image data, the identification information of a respective one of the imaging objects based on an image in the identification region, and to determine an order of the plurality of pieces of captured image data based on the identified identification information.

According to another aspect of the present disclosure, a non-transitory computer-readable storage medium stores a program. The program causes a computer to execute a process. The process includes acquiring a plurality of pieces of captured image data by capturing, with an imaging unit, images of a plurality of imaging objects on which respective pieces of identification information capable of identifying the plurality of imaging objects are written; causing a captured image based on each piece of the captured image data to be displayed on a display; acquiring at least one piece of identification region information indicating, in the captured image, an identification region in which the identification information is written and that is designated by an operation unit; identifying, for each piece of the captured image data, the identification information of a respective one of the imaging objects based on an image in the identification region; and determining an order of the plurality of pieces of captured image data based on the identified identification information.

### BRIEF DESCRIPTION OF THE DRAWINGS

FIG. 1 is a block diagram illustrating a schematic configuration of a printing system.

FIG. 2 illustrates a top screen of a print assistance program.

FIG. 3 is a flowchart illustrating operation of an information processing apparatus when a camera copy function is executed.

FIG. 4 illustrates a capture screen displayed when the camera copy function is executed.

FIG. 5 illustrates an extraction screen displayed when the camera copy function is executed.

FIG. 6 illustrates another extraction screen displayed when the camera copy function is executed.

FIG. 7 illustrates a captured image.

FIG. 8 illustrates a preview screen displayed when the camera copy function is executed.

FIG. 9 is a flowchart illustrating operation of the information processing apparatus when the camera copy function is executed in a second embodiment.

FIG. 10 illustrates an extraction screen in the second embodiment.

FIG. 11 illustrates a region designation screen displayed when the camera copy function is executed in the second embodiment.

FIG. 12 illustrates another region designation screen displayed when the camera copy function is executed in the second embodiment.

FIG. 13 illustrates a region designation screen in a third embodiment.

FIG. 14 illustrates another region designation screen in the third embodiment.

FIG. 15 illustrates still another region designation screen in the third embodiment.

FIG. 16 illustrates a captured image.

### DESCRIPTION OF EMBODIMENTS

### 1. First Embodiment

Hereinafter, a printing system 100 according to the present embodiment will be described with reference to the accompanying drawings.

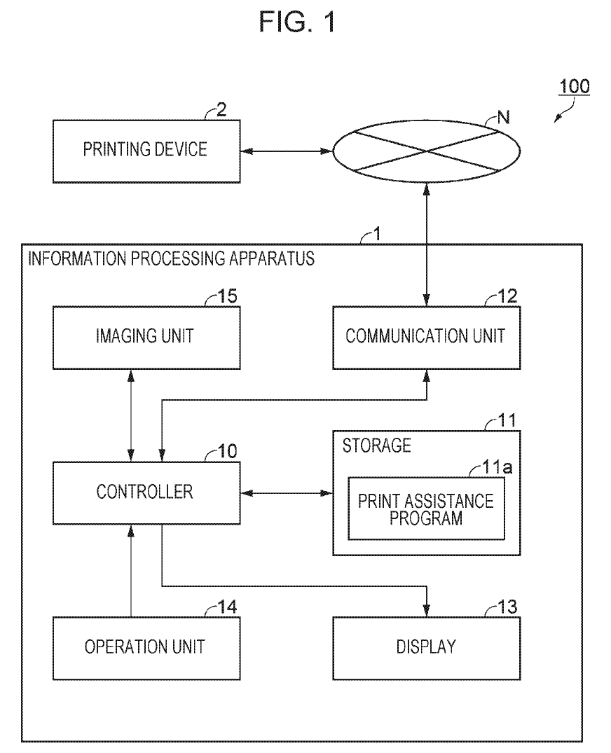

FIG. 1 is a block diagram illustrating a schematic configuration of the printing system 100.

As illustrated in FIG. 1, the printing system 100 includes an information processing apparatus 1 and a printing device 2. The information processing apparatus 1 is implemented by a terminal device such as a smartphone or a tablet terminal. However, the configuration of the information processing apparatus 1 is not limited thereto, and may be a notebook or desktop personal computer or the like. The printing device 2 is a printer that prints an image of a document or a photograph based on printing data input from the information processing apparatus 1. The printing method of the printing device 2 is not particularly limited and may be an ink jet method, a thermal printing method, or an electrophotographic printing method. In addition, a scanner that reads an original document sheet placed on a document table may be built into the printing device 2.

The information processing apparatus 1 includes a controller 10, a storage 11, a communication unit 12, a display 13, an operation unit 14, and an imaging unit 15. The controller 10 includes a processor such as a central processing unit (CPU), and controls the operation of the information processing apparatus 1 by executing an operating system (OS), an application program, or the like (not illustrated) stored in the storage 11. The controller 10 corresponds to a computer.

The storage 11 is implemented by a storage device such as a memory, and stores the OS, the application programs, various types of data, and the like described above.

The communication unit 12 is connected to a network N such as a Local Area Network (LAN). The communication unit 12 includes an interface circuit for communication over the network N, which enables communication with the printing device 2 connected to the network N. The connection between the communication unit 12 and the network N may be either wireless or wired.

The display 13 includes a display device such as a liquid crystal display or an organic electroluminescent (EL) display and displays various kinds of information under the control of the controller 10. The operation unit 14 receives input operations from a user and outputs operation information corresponding to the received input operation to the controller 10. In the present embodiment, the operation unit 14 is a touch panel integrally configured with the display 13 and receives tapping, dragging, or similar operations performed by the user. The operation unit 14 may alternatively be configured separately from the display 13, such as a keyboard, operation buttons, or a pointing device.

The imaging unit 15 is a camera including an imaging element (not illustrated) such as a charge-coupled device (CCD) sensor or a complementary metal-oxide-semiconductor (CMOS) sensor, an imaging lens (not illustrated), and the like. The imaging unit 15 captures an image within an imaging range facing the imaging lens and generates captured image data. The imaging unit 15 outputs the generated captured image data to the controller 10. Hereinafter, an image captured by the imaging unit 15, that is, an image based on the captured image data is also referred to as a captured image.

Various application programs (not illustrated) are stored in the storage 11 of the information processing apparatus 1. When an application program is started by the user, the controller 10 executes various processes. The storage 11 in the present embodiment stores, as an application program, a print assistance program 11a to be used when the printing device 2 performs printing. The print assistance program 11a is an example of such a program.

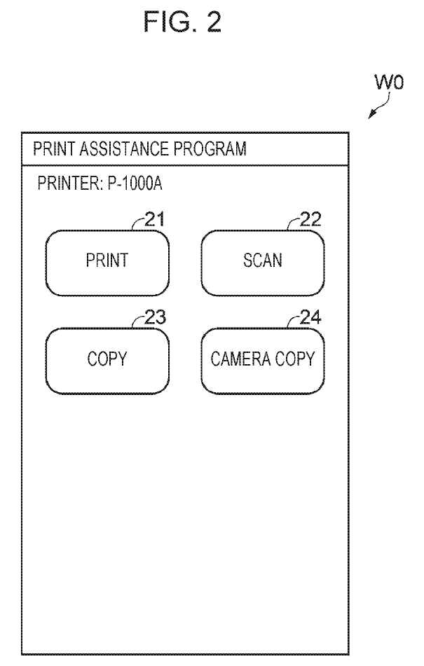

FIG. 2 illustrates a top screen W0 of the print assistance program 11a.

After the user starts the print assistance program 11a using the operation unit 14, the controller 10 executes various processes based on the print assistance program 11a. First, the controller 10 causes the top screen W0 illustrated in FIG. 2 to be displayed on the display 13.

As illustrated in FIG. 2, a print button 21, a scan button 22, a copy button 23, and a camera copy button 24 are displayed on the top screen W0. By tapping any of the buttons on the operation unit 14, the user can cause the information processing apparatus 1 and the printing device 2 to perform desired operations.

For example, by operating the print button 21, the user can cause the printing device 2 to print a document, a photograph, or the like stored in the storage 11 of the information processing apparatus 1. In addition, by operating the scan button 22, the user can cause the printing device 2 to read an original document sheet set on a document table as an image and store the image in the storage 11 of the information processing apparatus 1. Furthermore, by operating the copy button 23, the user can cause the printing device 2 to read an original document sheet set on the document table as an image and print the read image.

By operating the camera copy button 24, the user can use a camera copy function that causes the printing device 2 to print an image captured by the imaging unit 15 of the information processing apparatus 1. Use of the camera copy function enables an original document sheet to be copied by capturing an image of the sheet with the imaging unit 15. Therefore, copying of an original document sheet can be achieved even when a scanner is not built into the printing device 2.

With the camera copy function according to the present embodiment, when images of multiple original document sheets are individually captured by the imaging unit 15 and printed by the printing device 2, printing can be performed in an order based on the page numbers written on the original document sheets, rather than in the order in which the images are captured. That is, even if the user captures images of multiple original document sheets without paying attention to the sheet order, printing is performed in the order of the page numbers on the sheets. Accordingly, in double-sided printing in which printing is performed on both sides of a printing paper sheet, two original document sheets having non-consecutive page numbers are not printed on the front and back of the same printing paper sheet. In addition, in N-up printing in which multiple original document sheets are printed on a single printing paper sheet, the multiple original document sheets can be laid out in the order of their page numbers. In the camera copy function, an original document sheet whose image is to be captured is an example of an imaging object. In addition, the page numbers written on original document sheets are examples of identification information capable of identifying the original document sheets, respectively.

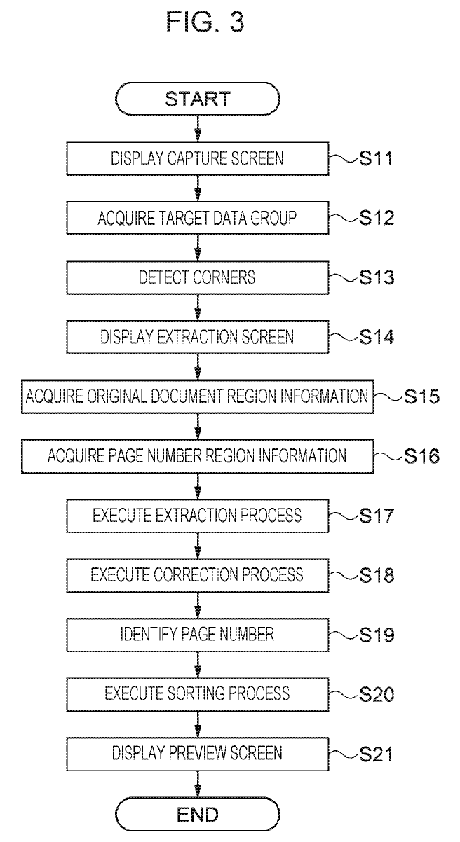

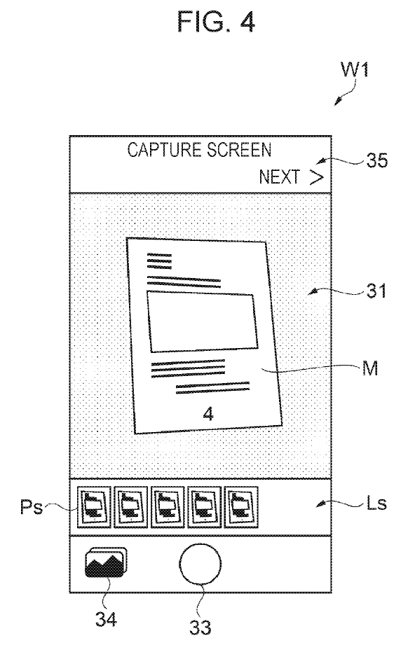

FIG. 3 is a flowchart illustrating operation of the information processing apparatus 1 when the camera copy function is executed, and FIG. 4 illustrates a capture screen W1 displayed when the camera copy function is executed. When the camera copy button 24 on the top screen W0 is operated by the user, the controller 10 operates according to the flow illustrated in FIG. 3.

As illustrated in FIG. 3, in step S11, the controller 10 causes the capture screen W1 illustrated in FIG. 4 to be displayed on the display 13. In step S12, the controller 10 acquires a target data group including a plurality of pieces of captured image data to be printed, based on a user's operation on the capture screen W1.

As illustrated in FIG. 4, the capture screen W1 includes a monitor region 31, an image list Ls, a shutter button 33, a reading instruction section 34, and a first execution instruction section 35. In the monitor region 31, the imaging range of the imaging unit 15 is displayed in real time. Therefore, when the user directs the imaging unit 15 toward the original document sheet M, which is an imaging target, the original document sheet M is displayed in the monitor region 31. When the imaging unit 15 and the original document sheet M are not exactly facing each other, the original document sheet M is displayed in a distorted trapezoidal shape. By tapping the shutter button 33 while referring to the image displayed in the monitor region 31, the user can capture an image of the original document sheet M. The captured image data generated through the image capture is stored in the storage 11 in a predetermined file format.

The user can capture images of a plurality of original document sheets M while the capture screen W1 is displayed. In this case, a plurality of pieces of the captured image data generated through the captures are associated with each other as a target data group. Accordingly, the controller 10 acquires a plurality of pieces of captured image data by causing the imaging unit 15 to capture images of a plurality of original document sheets M on which page numbers are written.

In the image list Ls, a list of reduced-size images Ps, which are thumbnail images based on the captured image data constituting the target data group, is displayed. Each time an image of the original document sheet M is captured, a new reduced-size image Ps is added to the right side of the existing reduced-size images Ps in the image list Ls. That is, the arrangement order of the reduced-size images Ps in the image list Ls represents the order in which the corresponding captured image data is added to the target data group. Each time an image of the original document sheet M is captured, the controller 10 assigns an arrangement number indicating the arrangement order in the image list Ls to each captured image.

Instead of capturing an image with the imaging unit 15, the user may read captured image data stored in advance in the storage 11 and add the image data to the target data group. In this case, the user taps the reading instruction section 34, and designates captured image data to be added on a file designation screen (not illustrated) displayed on the display 13. After the user finishes including all of the captured image data to be printed in the target data group, the user taps the first execution instruction section 35 on which "Next" is written. Then, in response to the user's operation on the first execution instruction section 35, the controller 10 determines the target data group and causes the process to proceed to step S13.

In step S13, for all pieces of the captured image data included in the target data group, the controller 10 detects the four corners of each captured original document sheet M. For example, a known image analysis technique can be applied to the corner detection. The positions of the detected corners are used to geometrically correct the shape of the original document sheet M, which appears distorted in a trapezoidal shape in the captured image.

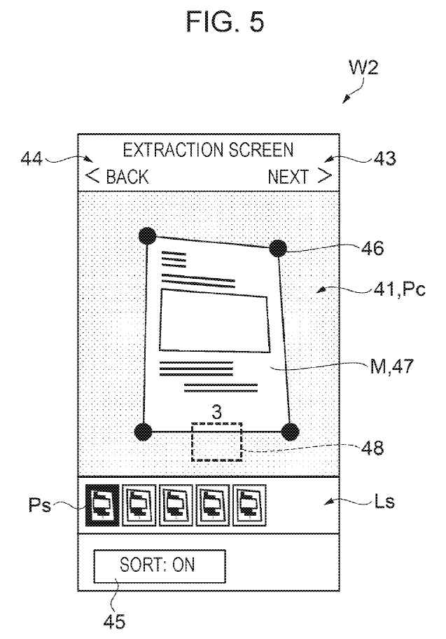

In step S14, the controller 10 causes an extraction screen W2, illustrated in FIG. 5, to be displayed on the display 13.

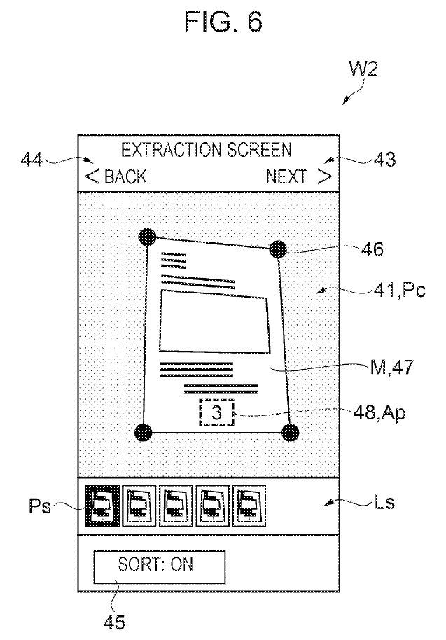

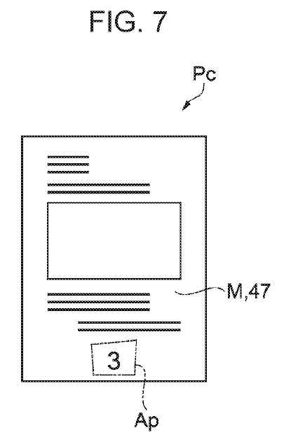

FIGS. 5 and 6 illustrate the extraction screen W2 displayed when the camera copy function is used, and FIG. 7 illustrates a captured image Pc.

As illustrated in FIG. 5, the extraction screen W2 includes a first work region 41, the image list Ls described above, a second execution instruction section 43, a first back-instruction section 44, and a sort-instruction section 45.

The first back-instruction section 44 is tapped by the user when the captured image data is to be added again to the target data group. Although not illustrated, when the first back-instruction section 44 is operated, the controller 10 returns the display 13 to the capture screen W1.

The sort-instruction section 45 is tapped by the user to specify whether the captured image data is to be sorted in accordance with the page numbers written on the original document sheets M. The sort-instruction section 45 displays a label "ON" or "OFF", which is switched each time the user operates the sort-instruction section 45. The captured image data is sorted when the label of the sort-instruction section 45 is "ON", and is not sorted when the label is "OFF". In the following, a case is explained in which the label in the sort-instruction section 45 is "ON", that is, where the captured image data is to be sorted. In the present embodiment, it is assumed that the positions of the page numbers are the same on all of the original document sheets M. Specifically, it is assumed that the page number is written at the center of the lower end of each original document sheet M.

Displayed in the first work region 41 is the captured image Pc, based on the captured image data, having an arrangement number of 1, that is, the captured image Pc corresponding to the reduced-size image Ps displayed at the left end of the image list Ls. In step S14, the controller 10 causes the captured image Pc based on the captured image data to be displayed on the display 13. In the captured image Pc, the circular markers 46 are superimposed on the four corners of the original document sheet M detected in step S13. If the position of a marker 46 deviates from the actual position of the corresponding corner of the original document sheet M, the user can correct the position by dragging the marker 46. Hereinafter, a quadrangular region having the four markers 46 as vertices is also referred to as an original document region 47.

In addition, a rectangular frame-shaped image 48 is superimposed on the captured image Pc displayed in the first work region 41. The frame-shaped image 48 is an image for designating, using the operation unit 14, a page number region Ap (refer to FIG. 6), which is a region in which a page number is written in the captured image Pc. The page number region Ap is an example of an identification region. The frame-shaped image 48 is superimposed when the captured image data is to be sorted. The user may move the frame-shaped image 48 by dragging its substantially center portion and may change the size and aspect ratio of the frame-shaped image 48 by dragging its peripheral portion. Then, as illustrated in FIG. 6, the user adjusts the position, size, and aspect ratio of the frame-shaped image 48 so that only the page number is included within the frame-shaped image 48. The region surrounded by the adjusted frame-shaped image 48 in the captured image Pc corresponds to the page number region Ap.

The user can switch the captured image Pc displayed in the first work region 41 by tapping the reduced-size image Ps in the image list Ls. The user checks whether the positions of the markers 46 are appropriate for all the captured images Pc, and adjusts the positions of the markers 46 as needed. As described above, in the present embodiment, since the positions of the page numbers are the same in all the original document sheets M, the page number region Ap may be designated using any one of the captured images Pc. Therefore, in the present embodiment, the frame-shaped image 48 is superimposed only on the captured image Pc having an arrangement number of 1, and is not superimposed on the other captured images Pc. The page number region Ap designated using the first captured image Pc is also applied to all the other captured images Pc.

When adjustment of the markers 46 is completed for all captured images Pc, the user taps the second execution instruction section 43 on which "Next" is displayed. Then, in response to the user's operation on the second execution instruction section 43, the controller 10 advances the process to step S15.

In step S15, the controller 10 acquires original document region information representing the original document region 47 for all captured images Pc. The original document region information is, for example, information indicating the positions of the four markers 46. In step S16, the controller 10 acquires page number region information representing the page number region Ap designated by the frame-shaped image 48, that is, the page number region Ap designated through the operation unit 14. The page number region information is, for example, information indicating the page number region Ap, that is, the positions of the four corners of the adjusted frame-shaped image 48. The page number region information is an example of identification region information.

In step S17, for all pieces of the captured image data, the controller 10 executes an extraction process of extracting the original document region 47 from each captured image Pc. Then, in step S18, for all pieces of the captured image data, the controller 10 executes a correction process of correcting the extracted original document region 47 into a rectangle. That is, in the correction process, image processing is performed to geometrically correct the original document sheet M. For example, a known image processing technique can be applied to the correction process. As a result, as illustrated in FIG. 7, each captured image Pc becomes an image including only the original document sheet M corrected into a rectangle shape. For the captured image Pc on which the frame-shaped image 48 is superimposed, the correction process is also applied to the page number region Ap. Therefore, as the trapezoidal original document region 47 is corrected into a rectangle, the rectangular page number region Ap is deformed into a trapezoid.

In step S19, for each piece of captured image data, the controller 10 identifies the page number of the original document sheet M based on the image in the page number region Ap. Specifically, the controller 10 identifies the page number by analyzing the image in the page number region Ap for all pieces of the corrected captured image data. For example, a known optical character recognition (OCR) technique can be applied to the identification of the page number. When characters other than numerals are included in the page number region Ap, the controller 10 ignores those characters.

In step S20, the controller 10 executes a sorting process of arranging the plurality of pieces of captured image data constituting the target data group in order from the smallest page number. In other words, the controller 10 determines the order of the captured image data based on the identified page number. Specifically, the controller 10 changes the arrangement number assigned to each piece of captured image data so that the plurality of pieces of captured image data are arranged in ascending order of page numbers.

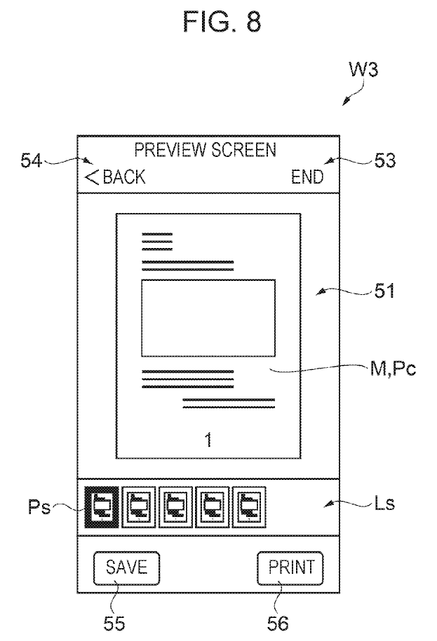

In step S21, the controller 10 causes a preview screen W3, illustrated in FIG. 8, to be displayed on the display 13.

FIG. 8 illustrates the preview screen W3 displayed when the camera copy function is used.

As illustrated in FIG. 8, the preview screen W3 includes a preview region 51, the image list Ls described above, an end instruction section 53, a second back-instruction section 54, a save button 55, and a print button 56.

The second back-instruction section 54 is tapped by the user when the extraction process and the correction process are to be performed again. Although not illustrated, when the second back-instruction section 54 is operated, the controller 10 returns the captured image data to the state before the extraction process in step S17 is executed, and returns the display 13 to the extraction screen W2.

In the preview region 51, the captured image Pc of the captured image data having the arrangement number of 1, which results from the sorting process, that is, the captured image Pc of the original document sheet M having the smallest page number is displayed in a state in which the extraction and correction processes have been performed. By tapping the reduced-size image Ps in the image list Ls, the user can switch the captured image Pc displayed in the preview region 51. Then, the user checks, as needed, whether the extraction, correction, and sorting processes have been properly executed based on the captured image Pc displayed in the preview region 51.

By tapping the save button 55, the user can cause the target data group after execution of the extraction, correction, and sorting processes to be stored in the storage 11. In response to the user's operation on the save button 55, the controller 10 causes a file save screen (not illustrated) to be displayed on the display 13. Then, the controller 10 causes the target data group to be stored in the storage 11 based on the user's instruction on the file save screen. The target data group is stored, for example, as a single portable document format (PDF) file in which the captured images Pc are allocated to pages in order of their arrangement numbers.

In addition, by tapping the print button 56, the user can cause the printing device 2 to print the target data group after the extraction, correction, and sorting processes. In response to the user's operation on the print button 56, the controller 10 causes a print setting screen (not illustrated) to be displayed on the display 13. Then, the controller 10 causes the printing device 2 to print the plurality of captured images Pc included in the target data group based on the user's instruction on the print setting screen. At this time, the captured images Pc are printed in order of arrangement numbers, that is, in order of their page numbers.

After saving or printing the target data group as needed, the user can complete the camera copy function by tapping the end instruction section 53. In response to the user's operation on the end instruction section 53, the controller 10 terminates the camera copy function and returns the display 13 to the top screen W0.

As described above, according to the information processing apparatus 1 and a storage medium storing the print assistance program 11a in the present embodiment, the following effects can be obtained.

According to the present embodiment, the controller 10 identifies the page number of the original document sheet M based on the image in the page number region Ap designated by the user, and determines the order of the captured image data based on the identified page number. That is, it is unnecessary for the user to individually specify the order, thereby enabling the order of the captured image data to be easily determined.

In addition, according to the present embodiment, since the controller 10 executes the correction process for geometrically correcting the original document sheet M for the captured image data, the original document sheet M in the captured image can be arranged in an appropriate shape.

### 2. Second Embodiment

In the print assistance program 11a according to the second embodiment, some of the operations in the camera copy function differ from those in the first embodiment. Other configurations are the same as in the first embodiment and therefore their detailed descriptions are omitted.

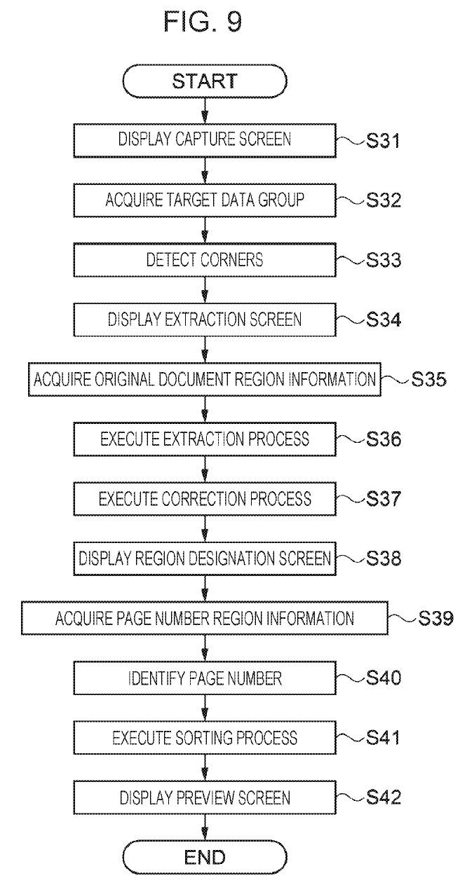

FIG. 9 is a flowchart illustrating operation of the information processing apparatus 1 when the camera copy function is executed in the second embodiment.

As illustrated in FIG. 9, steps S31 to S33 are the same as steps S11 to S13 in the first embodiment. That is, in step S31, the controller 10 causes the capture screen W1 to be displayed on the display 13, and in step S32, acquires a target data group including a plurality of pieces of captured image data based on a user's operation on the capture screen W1. When the first execution instruction section 35 is operated by the user and the process proceeds to step S33, the controller 10 detects the four corners of the captured original document sheet M for all pieces of captured image data included in the target data group.

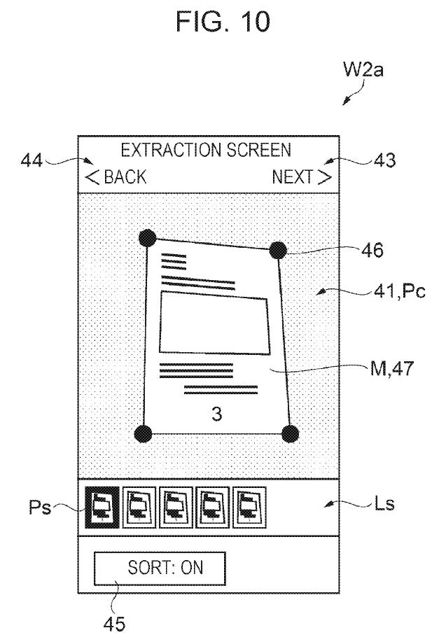

In step S34, the controller 10 causes the extraction screen W2a, illustrated in FIG. 10, to be displayed on the display 13.

FIG. 10 illustrates the extraction screen W2a in the second embodiment.

As illustrated in FIG. 10, the extraction screen W2a has the same configuration as the extraction screen W2 in the first embodiment, except that the frame-shaped image 48 is not superimposed. That is, the user adjusts the positions of the markers 46 on the extraction screen W2a as needed, but does not designate the page number region Ap using the frame-shaped image 48.

When adjustment of the markers 46 is completed for all captured images Pc, the user taps the second execution instruction section 43 on which "Next" is displayed. Then, in response to the user's operation on the second execution instruction section 43, in step S35, the controller 10 acquires the original document region information representing the original document region 47 for all captured images Pc. The operation of step S35 is the same as that of step S15 in the first embodiment.

In step S36, as in step S17 in the first embodiment, the controller 10 executes the extraction process of extracting the original document region 47 from each captured image Pc for all pieces of the captured image data. In step S37, as in step S18 in the first embodiment, the controller 10 executes a correction process of correcting the extracted original document region 47 into a rectangle for all pieces of captured image data.

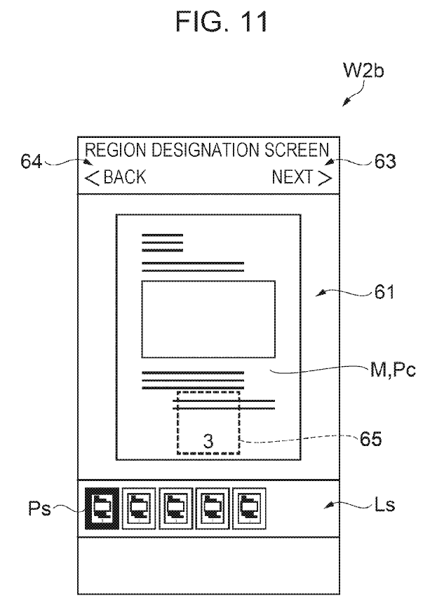

In step S38, the controller 10 causes a region designation screen W2b, illustrated in FIG. 11, to be displayed on the display 13.

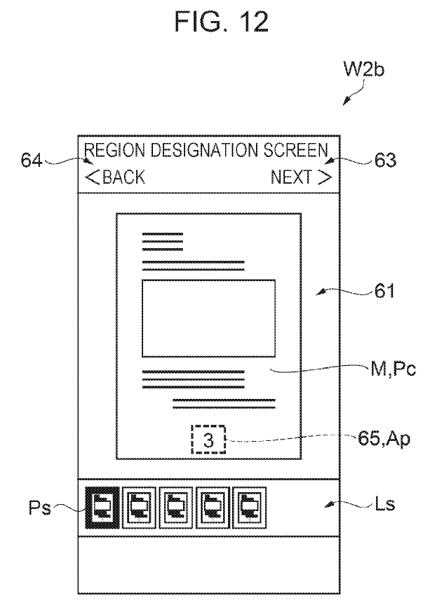

FIGS. 11 and 12 illustrate the region designation screen W2b displayed when the camera copy function is used in the second embodiment. When the label of the sort-instruction section 45 is "ON", that is, when the captured image data is to be sorted, the controller 10 causes the region designation screen W2b to be displayed after the extraction screen W2a.

As illustrated in FIG. 11, the region designation screen W2b includes a second work region 61, the image list Ls described above, a third execution instruction section 63, and a third back-instruction section 64.

The third back-instruction section 64 is tapped by the user when the original document region 47 is to be extracted again. Although not illustrated, in response to the operation on the third back-instruction section 64, the controller 10 returns the display 13 to the extraction screen W2a.

In the second work region 61, the captured image Pc based on the captured image data having an arrangement number of 1, that is, the captured image Pc corresponding to the reduced-size image Ps displayed at the left end of the image list Ls is displayed. The captured image Pc is based on the captured image data subjected to the correction process in step S37 and includes only the original document sheet M corrected into a rectangular shape.

A rectangular frame-shaped image 65 for designating the page number region Ap is superimposed on the captured image Pc displayed in the second work region 61. As illustrated in FIG. 12, the user adjusts the position, size, and aspect ratio of the frame-shaped image 65 so that only the page number is included within the frame-shaped image 65. Also in the present embodiment, the frame-shaped image 65 is superimposed only on the captured image Pc having an arrangement number of 1, and is not superimposed on the other captured images Pc.

When designation of the page number region Ap is completed, the user taps the third execution instruction section 63 on which "Next" is displayed. Then, in response to the user's operation on the third execution instruction section 63, in step S39, the controller 10 acquires page number region information representing the page number region Ap designated using the frame-shaped image 65. The operation of step S39 is the same as that of step S16 in the first embodiment. However, in the present embodiment, unlike the first embodiment, the controller 10 acquires the page number region information based on the captured image data after the correction process.

In step S40, as in step S19 in the first embodiment, for each piece of captured image data, the controller 10 identifies the page number of the original document sheet M based on the image in the page number region Ap. In step S41, as in step S20 in the first embodiment, the controller 10 executes a sorting process of arranging the plurality of pieces of captured image data constituting the target data group in order from the smallest page number.

In step S42, as in step S21 in the first embodiment, the controller 10 causes the preview screen W3 to be displayed on the display 13. The configuration of the preview screen W3 is the same as that in the first embodiment, and therefore its detailed description is omitted.

As described above, according to the information processing apparatus 1 and the storage medium storing the print assistance program 11a in the present embodiment, the following effects can be obtained in addition to the effects of the first embodiment.

According to the present embodiment, the controller 10 acquires the page number region information based on the captured image data after the correction process, thereby enabling the page number region Ap to be obtained in an appropriate shape, that is, in a shape corresponding to the original shape of the original document sheet M.

### 3. Third Embodiment

In the first and second embodiments described above, the frame-shaped image 48 or 65 is superimposed on only one captured image Pc. In other words, only one page number region Ap can be specified. In contrast, in the present embodiment, a plurality of page number regions Ap at different positions can be designated for one target data group. This enables the page numbers to be appropriately identified even when their positions are not constant, for example, even when the page-number position differs between the odd-numbered pages and the even-numbered pages.

In the present embodiment, it is assumed that the positions of the page numbers differ between the odd-numbered pages and the even-numbered pages of captured original document sheets M. Specifically, it is assumed that the page number is written on the right side of the lower end of the original document sheet M for an odd-numbered page, and on the left side of the lower end of the original document sheet M for an even-numbered page. Hereinafter, the third embodiment will be described focusing on the differences from the second embodiment.

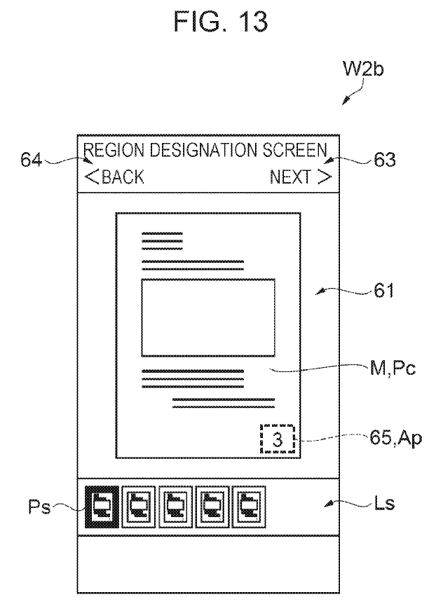

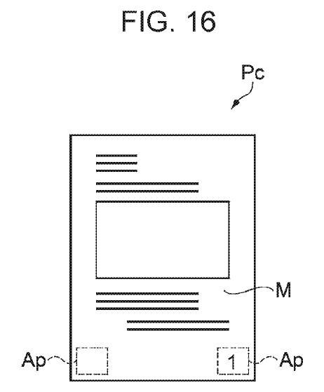

FIGS. 13 to 15 illustrate the region designation screen W2b in the third embodiment, and FIG. 16 illustrates the captured image Pc.

As illustrated in FIG. 13, when the region designation screen W2b is displayed in step S38 (refer to FIG. 9), the user first designates a first page number region Ap. For example, when the page number of the original document sheet M is an odd number in the captured image Pc having an arrangement number of 1, that is, the captured image Pc displayed in the second work region 61, the user adjusts the position, size, and aspect ratio of the frame-shaped image 65 so that only the page number at the lower right is included within the frame-shaped image 65.

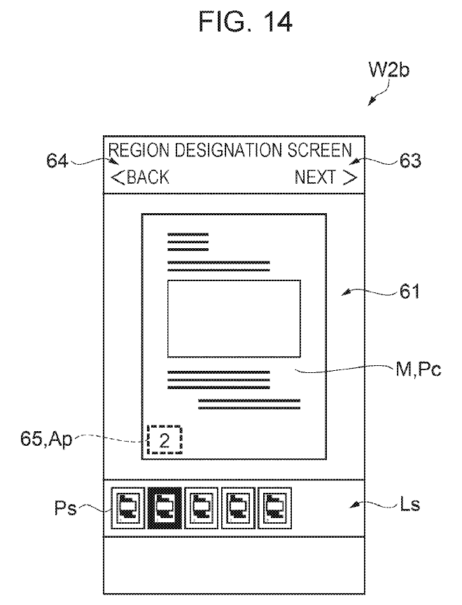

Next, the user designates a second page number region Ap. Specifically, as illustrated in FIG. 14, the user operates the image list Ls to display the captured images Pc having even-numbered pages in the second work region 61. The user then adjusts the position, size, and aspect ratio of the frame-shaped image 65 so that only the page number at the lower left is included within the frame-shaped image 65.

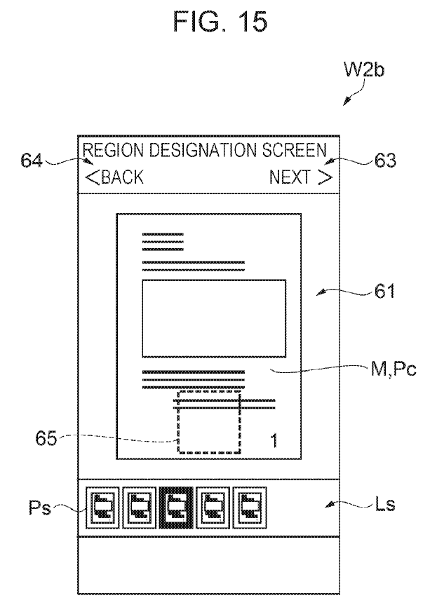

After the page number regions Ap for both odd-numbered and even-numbered pages have been designated, the user does not need to designate a page number region Ap in any other captured image Pc. For example, as illustrated in FIG. 15, when the user displays another captured image Pc in the second work region 61, the frame-shaped image 65 is also superimposed on this captured image Pc. However, the user does not adjust the position, size, or aspect ratio of the frame-shaped image 65.

When designation of the page number regions Ap for both the odd-numbered and the even-numbered pages is complete and the third execution instruction section 63 is operated by the user, the controller 10, in step S39, acquires two pieces of page number region information representing the two page number regions Ap designated using the frame-shaped image 65.

In step S40, the controller 10 identifies the page number of the original document sheet M based on the images in the two page number regions Ap indicated by the acquired two pieces of page number region information. That is, the controller 10 identifies the page number of the original document sheet M by analyzing the images in the two page number regions Ap. At this time, for the captured image Pc in which the first page number region Ap is designated, the controller 10 identifies the page number by analyzing only the first page number region Ap. Similarly, for the captured image Pc in which the second page number region Ap is designated, the controller 10 identifies the page number by analyzing only the second page number region Ap. Then, as illustrated in FIG. 16, for any other captured image Pc, that is, the captured image Pc in which the page number region Ap is not designated, the controller 10 identifies the page number by analyzing both page number regions Ap. Regardless of whether the page number is odd or even, since the page number appears in one of the two page number regions Ap, the controller 10 can appropriately identify the page number. The subsequent operation is the same as that in the second embodiment.

As described above, according to the information processing apparatus 1 and the storage medium storing the print assistance program 11a in the present embodiment, the following effects can be obtained in addition to those of the first and second embodiments.

According to the present embodiment, because the controller 10 identifies the page number based on the images in the two page number regions Ap, the page number can be identified appropriately even when the position at which the page number is written differs depending on the original document sheet M. The number of page number regions Ap in the present embodiment is not limited to two and may be three or more.

In addition, according to the present embodiment, for a captured image Pc in which the page number region Ap is designated, only the designated page number region Ap is analyzed. This reduces the time required for the analysis compared with a case in which all of the page number regions Ap in all captured images Pc are analyzed. However, all page number regions Ap in all captured images Pc may instead be analyzed.

Furthermore, in the present embodiment, since the page number is written at one of two positions, the lower right and the lower left of the original document sheet M, the user designates the page number region Ap in two captured images Pc. That is, if the user designates the page number region Ap as many captured images Pc as the number of positions where the page number can be written, the user need not designate the page number region Ap in the other captured images Pc. This can reduce the number of man-hours required when a plurality of page number regions Ap are designated.

Although, in the present embodiment, the case in which a plurality of page number regions Ap can be designated is applied to the second embodiment, the same case may also be applied to the first embodiment.

### 4. Modifications

Each of the embodiments described above is based on the above-described configuration; however, the configuration may be partially changed or omitted without departing from the scope of the present disclosure. In addition, the present embodiment and the modifications described below may be implemented in combination with each other as long as there is no technical contradiction. Hereinafter, several modifications will be described.

In each of the above-described embodiments, the page number is used as identification information for identifying each of the original document sheets M, which are the imaging objects. However, the identification information of the imaging object is not limited to the page number. For example, if date information written at a specific position on the imaging object is used as the identification information, the captured image data can be sorted in date order. In addition, if character string information written at a specific position on the imaging object is used as the identification information, the captured image data can be arranged in character-string order. When the identification information is date information or character string information, it is desirable to designate whether the sorting is to be performed in ascending or descending order.

As described above, the identification information is preferably any one of page numbers, date information, and character string information. According to this configuration, the controller 10 can easily determine the order of the captured image data in accordance with any one of a page number, a date, and a character string written on the imaging object.

In each of the above-described embodiments, the imaging object is not limited to the original document sheet M such as a paper sheet. The imaging object may be any object on which characters, numerals, or the like are written, and may be, for example, a three-dimensional object.

In the second embodiment described above, the frame-shaped image 65 for designating the page number region Ap is superimposed only on the captured image Pc having the first arrangement number. However, the present disclosure is not limited to this. For example, the frame-shaped images 65 may be superimposed on all the captured images Pc, thereby allowing the position, size, and aspect ratio of the frame-shaped image 65 to be adjusted for each captured image Pc. In this case, the adjustment result obtained by adjusting the frame-shaped image 65 in one captured image Pc is also reflected in the frame-shaped image 65 superimposed on another captured image Pc.

In each of the embodiments described above, when an image of an imaging object such as the original document sheet M is captured by the imaging unit 15 of the information processing apparatus 1, a fixing unit that appropriately fixes the positional relationship between the imaging unit 15 and the imaging object may be used. In this case, the position and shape of the imaging object in the captured image Pc are constant, and the distortion of the imaging object can be further suppressed. Therefore, the correction process in step S18 or step S37 becomes unnecessary.

What is claimed is:

1. An information processing apparatus comprising:
an imaging unit;
a display;
an operation unit; and
a controller,
wherein the controller is configured to
acquire a plurality of pieces of captured image data by capturing, with the imaging unit, images of a plurality of imaging objects on which respective pieces of identification information capable of identifying the plurality of imaging objects are written,
cause a captured image based on each piece of the captured image data to be displayed on the display,
acquire at least one piece of identification region information indicating, in the captured image, an identification region in which the identification information is written and that is designated by the operation unit,
identify, for each piece of the captured image data, the identification information of a respective one of the imaging objects based on an image in the identification region, and
determine an order of the plurality of pieces of captured image data based on the identified identification information.

2. The information processing apparatus according to claim 1, wherein the controller is configured to perform a correction process for geometrically correcting the plurality of imaging objects for the plurality of pieces of captured image data.

3. The information processing apparatus according to claim 2, wherein the controller is configured to acquire the at least one piece of identification region information based on each piece of the captured image data after the correction process.

4. The information processing apparatus according to claim 1, wherein
the at least one piece of identification region information includes a plurality of pieces of identification region information, and
the controller is configured to
acquire the plurality of pieces of identification region information, and
identify the identification information of a respective imaging object based on images in the plurality of identification regions represented by the plurality of pieces of acquired identification region information.

5. The information processing apparatus according to claim 1, wherein the identification information is any one of a page number, date information, and character string information.

6. A non-transitory computer-readable storage medium storing a program that causes a computer to execute a process, the process comprising:
acquiring a plurality of pieces of captured image data by capturing, with an imaging unit, images of a plurality of imaging objects on which respective pieces of identification information capable of identifying the plurality of imaging objects are written;
causing a captured image based on each piece of the captured image data to be displayed on a display;
acquiring at least one piece of identification region information indicating, in the captured image, an identification region in which the identification information is written and that is designated by an operation unit;
identifying, for each piece of the captured image data, the identification information of a respective one of the imaging objects based on an image in the identification region; and
determining an order of the plurality of pieces of captured image data based on the identified identification information.
